(19) United States
(12) Patent Application Publication
(10) Pub. No.: US 2005/0275270 A1
(43) Pub. Date: Dec. 15, 2005

(54) Reclining device for automobile seat

(76) Inventor: Jae Hwan Lee, Kyung Ju (KR)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/132,624

(22) Filed: May 18, 2005

(30) Foreign Application Priority Data
May 18, 2004 (KR) 10-2004-0035216

(51) Int. Cl. B60N 2/02; B60N 2/48

(52) U.S. Cl. 297/367

(57) ABSTRACT

An improved automobile seat reclining device is presented. In exemplary embodiments of the present invention the automobile seat reclining device comprises a lower plate and an upper plate which are attached to the cushion frame and back-support frame of an automobile seat, respectively, and where the upper and lower plates are connected by a shaft that goes through the center hole of each plate. The device further comprises a lock gear, which engages and disengages with gear teeth that are formed in either the upper plate or the lower plate; a cam which pressurizes the lock gear towards the gear teeth in connection with the rotation of the shaft; and a pair of lock levers fixed upon a hinge pin, where one end of a lock lever contacts with the cam, and the other end makes contact or moves away from a side of the lock-gear as the cam rotates.

### TECHNICAL FIELD

The present invention relates to automobile seats. More precisely, it relates to an improved reclining device for automobile seats. that supports a lock gear in a stable state.

### CROSS REFERENCE TO OTHER APPLICATIONS

This application claims the benefit of Korean Patent Application No. 10-2004-0035216, filed on May 18, 2004, with DAS Co., Ltd. as Applicant, which is hereby incorporated herein by this reference as if fully set forth.

### BACKGROUND OF THE INVENTION

A reclining device, as described herein, is a device which allows a driver and/or a front seat passenger of an automobile to control the angle of the back support of their seats.

FIGS. 1 and 2 illustrate conventional reclining devices. With reference thereto, reclining device 1 includes a lower plate 4 which is fixed to the cushion (seat) frame and an upper plate 5 which is fixed to the back-support frame of an automobile-type seat. Lower plate 4 and upper plate 5 are connected by shaft 3, which passes through the central hole 2 of each plate, to enable their relative rotation.

FIG. 1 illustrates an “inner-type” recliner, which includes lock-gear 6 and cam 7, which are located within the space between lower plate 4 and upper plate 5. Lock-gear 6 engages and disengages with gear teeth 8, formed in the interior of the bottom portion of upper plate 5, thus allowing the angle of the back support relative to the cushion to be adjusted.

FIG. 2 depicts a variant to the recliner of FIG. 1, being an “outer-type” recliner that has gear teeth 8 formed on the exterior of the top portion of lower plate 4, and where lock gear 6 is fixed on the exterior of upper plate 5.

Both the inner-type (FIG. 1) and outer-type (FIG. 2) recliners include a pair of guides 10, which protrude from upper plate 5 and enable lock-gear 6 to slide between guides 10 as it is engaged or disengaged with the gear teeth.

The problem with conventional designs is their failure to adequately distribute this load. As noted above, in conventional recliners the lock's position (and thus the relative positions of back-support and seat cushion) is maintained by the engagement of the lock-gear with the gear teeth. Thus, any torque formed by a passenger's load on the back-support is transferred to the lock-gear. Such loads can be substantial. Load which is received by the lock-gear is also transferred to the guides which contact with the lock-gear. As a result the guides often experience substantial fatigue.

As this fatigue accumulates, it can result in damage to the reclining device's parts, and/or in the separation of the lock-gear from the upper plate guides at the guides' weakest position. This effect can prevent the reclining device from performing its primary function, which is to guide the lock-gear while maintaining a stable state. What is thus needed in the art is an improved reclining device that obviates these problems of the prior art.

### SUMMARY OF THE INVENTION

In exemplary embodiments of the present invention an improved reclining device includes a pair of lock levers, where one end of a lock lever contacts with the side of a lock-gear and the other end contacts with a cam to circulate the load transferred to the lock-gear. The reclining device according to the present invention thus enables a lock state to be stably maintained.

### BRIEF DESCRIPTION OF THE DRAWINGS

FIG. 1 illustrates a conventional inner-type automobile seat reclining device;

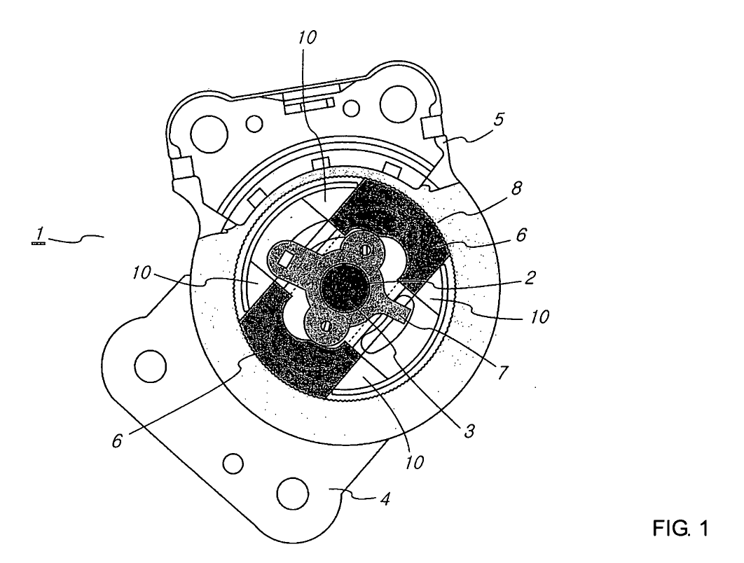

FIG. 2 illustrates a conventional outer-type automobile seat reclining device;

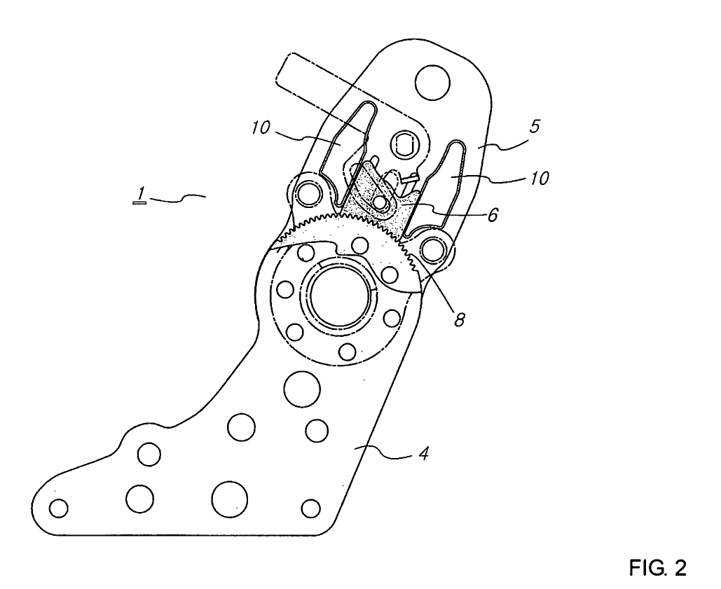

FIG. 3 is an exploded view of an inner-type reclining device according to an exemplary embodiment of the present invention;

FIG. 4 is an assembled view of an inner-type reclining device according to an exemplary embodiment of the present invention;

FIG. 5 is a partial section-view of a lock-gear and a guide according to an exemplary embodiment of the present invention;

FIG. 6 is an exploded view of an outer-type reclining device according to an exemplary embodiment of the present invention; and

FIG. 7 is an assembled view of the outer-type reclining device of FIG. 6.

### DETAILED DESCRIPTION OF THE INVENTION

The present invention will next be described more fully with reference to the accompanying drawings, in which some, but not all embodiments of the invention are shown. Indeed, the invention may be embodied in many different forms and should not be construed as being limited to the embodiments set forth herein, which are merely exemplary and presented so as to facilitate the description of the present invention.

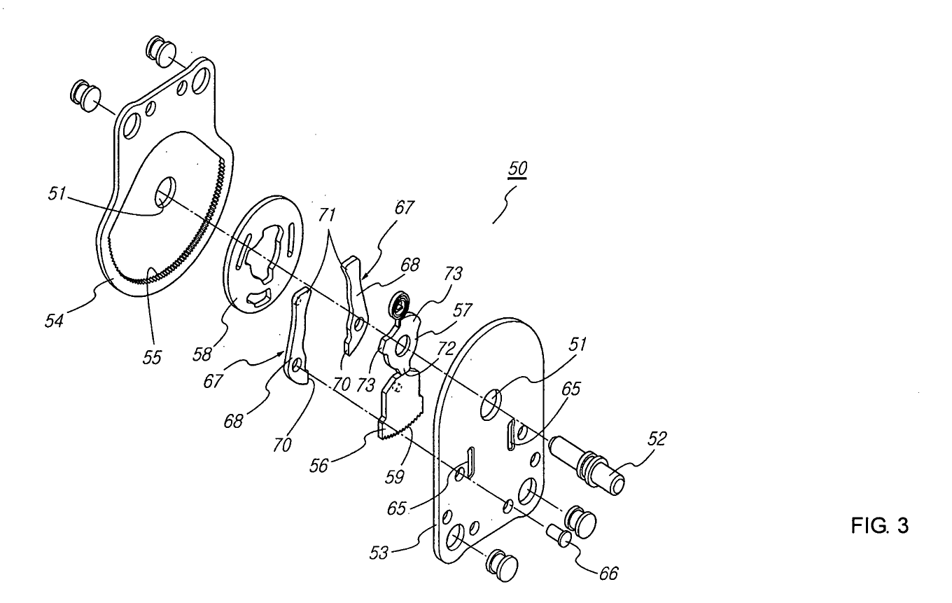

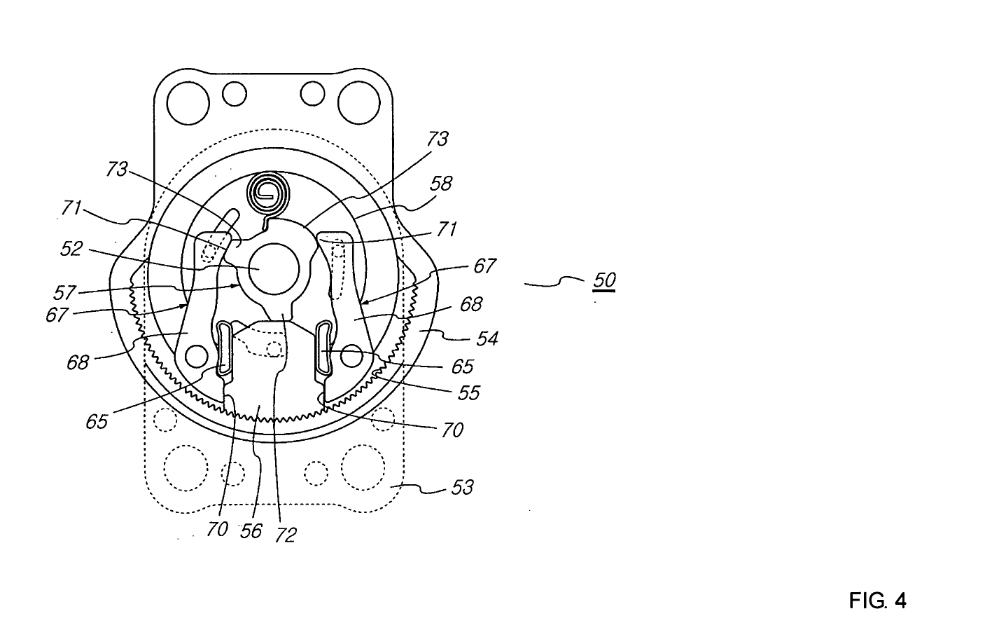

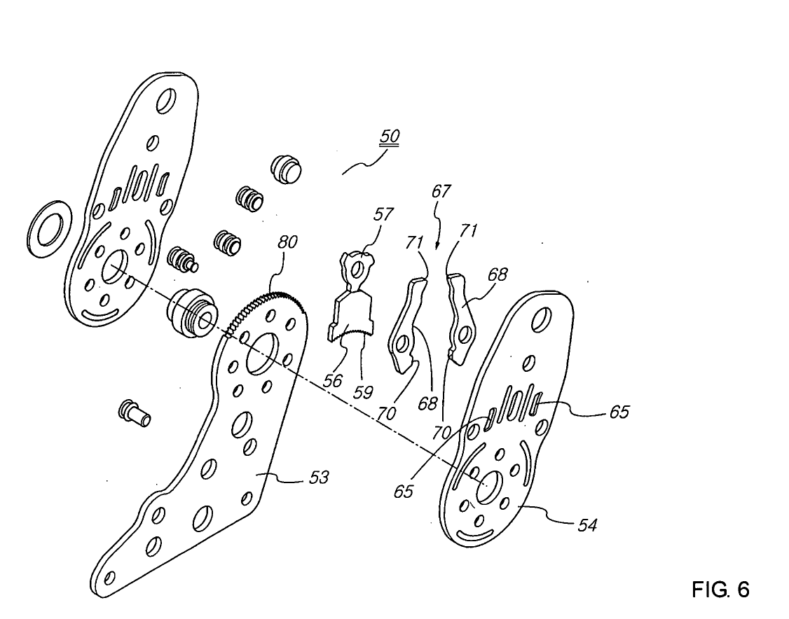

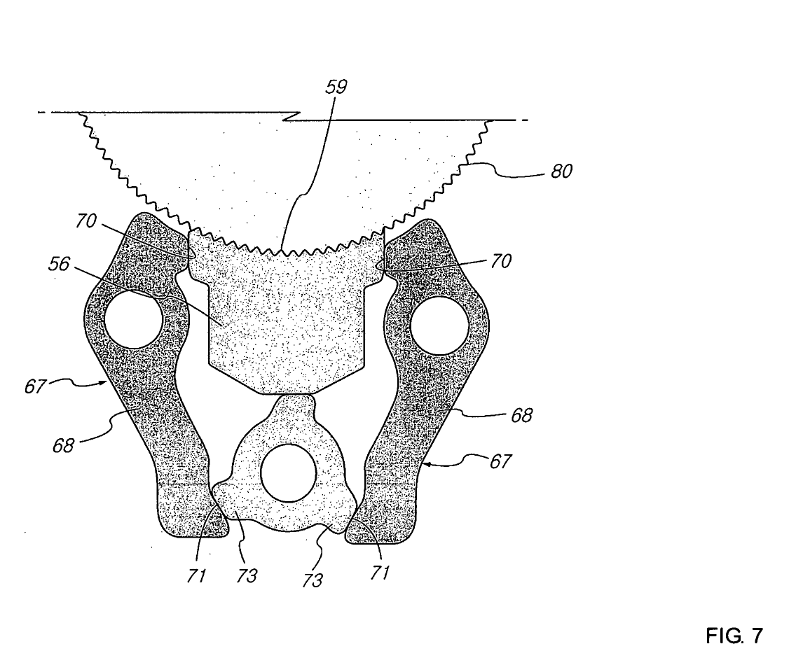

The present invention can be applied, for example, to an inner-type reclining device, as is illustrated in FIGS. 3 and 4, and also, for example, to an outer-type reclining device, as is illustrated in FIGS. 6 and 7.

FIGS. 3 and 4 are exploded and assembled views, respectively, of an inner-type reclining device according to an exemplary embodiment of the present invention. With reference to FIGS. 3 and 4, an exemplary inner-type reclining device 50 comprises, in addition to a conventional structure as described above, a pair of lock levers 67, where one end of a lock lever 67 contacts with the side of lock-gear 56 and the other end contacts with cam 57 to circulate the load that is transferred to lock-gear 56.

Further, the exemplary inner-type reclining device 50 includes, for example, a lower plate 53 which is fixed to the cushion frame and an upper plate 54 which is fixed to the back-support frame. The lower plate 53 and upper plate 54 are, for example, combined by shaft 52, which passes through the central hole of each plate 53, 54 to enable relative rotation.

An exemplary inner-type reclining device 50 can, for example, also include lock-gear 56 and cam 57, which can, for example, be located in the space between lower plate 53 and upper plate 54. Lock-gear 56 can, for example, engage and disengage with gear teeth 55 which can be formed, for example, on the interior of the bottom portion of upper plate 54. This allows the angle of the back support relative to the cushion to be adjusted and controlled. A lever spring can, for example, be installed to the side of lower plate 53 to provide shaft 52 with a returning force. The return spring, which can contact and pressurize cam 57, can, for example, be attached at the side of cam 57.

With reference to FIG. 4, a pair of lock guides 65 can, for example, be formed at lower plate 53, and lock-gear 56 can, for example, slide between the guides.

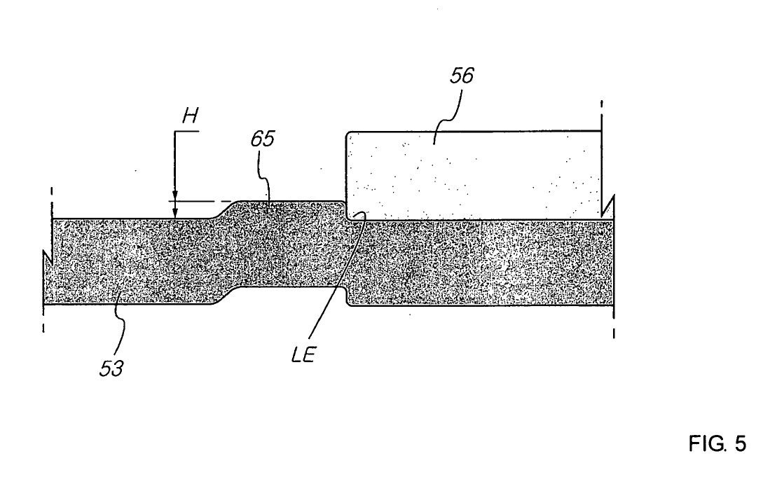

As is illustrated in FIG. 5, the protruding height H of lock guide 65 just has to be sufficient enough to prevent lock-gear 56 from escaping from the guides by supporting the lower part LE of lock-gear 56 when the lock-gear slides due to the rotation of cam 57 and cam plate 58 (with reference to FIGS. 3 and 4).

Lock levers 67 can, for example, connect with lower plate 53 by hinge pin 66, and can, for example, pivot around the axis of hinge pin 66. Lock levers 67 can comprise a flat lever-body 68, where a gear-supporting part 70 is formed at the end of the lever-body 68 and extends toward the lock levers 67, and contacts the sides 69 of lock-gear 56 and supports the lock-gear.

At the other end of lever-body 68, there can be formed a cam contacting part 71 which extends towards cam 57. Additionally, at the upper part of lever-body 68, a protruding part can be formed and inserted into a slot of cam plate 58.

Cam 57 can comprise gear pushing part 72 which can extend radially and push lock-gear 56 to engage with the gear teeth 55 of upper plate 54, and can also comprise lever pushing part 73 which can protrude radially to push lock levers 67 to support lock gear 56.

FIGS. 6 and 7 are exploded and assembled views, respectively, of an outer-type reclining device according to an exemplary embodiment of the present invention, as next described.

FIG. 6 is an exploded view of an exemplary outer-type reclining device according to the present invention. Apart from the fact that the lock-gear 56 (now having a concave bottom surface) and the cam 57 are installed at the side of upper plate 54, and the lock teeth 59 of lock-gear 56 engage with the lower teeth 80 which are formed at the top of lower plate 53, the basic mechanism of the outer-type reclining device is the same as that of the inner-type reclining device described above with reference to FIGS. 34.

The function of the two exemplary embodiments described above is as follows. When a driver or passenger pulls the control lever to control the angle of the back-support, shaft 52 and cam plate 57 rotate. According to the rotation of the cam plate 57, the lock gear 59, which is connected with the slot of the cam plate, slides toward the cam and becomes disengaged. In such disengaged state, lock lever 67, which is connected with the slot of the cam plate 58 by protrusion, moves toward the cam 57 and the gear supporting part 70 of the lock lever moves away from lock gear 56. In this configuration the upper plate can be freely moved relative to the lower plate.

When the driver or passenger releases the control lever after the back-support has been adjusted to a desired angle, shaft 52 and connected cam 57 rotate back due to the return spring or lever spring, as described above. Due to this rotation, the gear pushing part 72 of cam 57 once again pushes on lock gear 56 and lock gear 56 once again becomes engaged with gear teeth 55 or 80, as the case may be.

Simultaneously, in such engaged state, depicted in FIG. 4 for the inner-type embodiment and in a close-up view in FIG. 7 for the outer-type embodiment, the lever pushing part 73 of cam 57 pressurizes the cam connecting part 71 of lock lever 67 outwards, and thus lock lever 67 rotates around the axis of hinge pin 66 so that the gear supporting part 70 of the lock lever contacts the side 69 of lock gear 56 and thus supports the lock gear.

When looking at the load transfer in such configuration, a right load (i.e., a load on the right side of the lock gear pushing outward to the right) which is transferred to lock gear 56 in the engaging state is then transferred to the cam through the right lock lever 67. From cam 57, it is again transferred back to the lock gear 56 in anti-clockwise direction, forming a circle. Similarly, a left load (i.e., a load on the left side of the lock gear, pushing outward to the left) is transferred to the cam through the left lock lever 67, and from cam 57 it is again transferred back to the lock gear 56 in clockwise direction, forming a circle.

Such circulation of load enhances the engagement force, increases stability, and prevents the components of a reclining device 50 from damage and fatigue. In the above-described embodiments, the cam and the cam plate move the lock gear back and forth to control the engaging and disengaging states. However, the same principle can also apply to recliners where only a cam is used to move the lock gear back and forth.

The present invention has been described in connection with exemplary embodiments and implementations, as examples only. It will be understood by those having ordinary skill in the pertinent art that modifications to any of the embodiments or preferred embodiments may be easily made without materially departing from the scope and spirit of the present invention which is defined by the appended claims.

1. A reclining device for an automobile seat, comprising:
a lower plate and an upper plate which are attached to the cushion frame and back-support frame of an automobile seat respectively, and which are connected by a shaft that goes through the center hole of each plate;
a lock gear, which engages and disengages with the gear teeth that are formed in the upper plate or the lower plate;
a cam which pressurizes the lock gear towards the gear teeth in connection with the rotation of the shaft; and
a pair of lock levers fixed upon a hinge pin,
wherein as the cam rotates one end of the lock lever contacts with the cam, and the other end makes contact or moves away from the side of the lock-gear.

2. The reclining device of claim 1, wherein the cam has a number of protrusions radially protruding, such that when the cam rotates, the protrusions pressurize the lock levers outward.

3. The reclining device of claim 1, further comprising a cam plate, which has a slot in which a protrusion of the lock gear is inserted, moves the lock gear toward the cam in connection with the rotation of the shaft.

4. The reclining device of claim 3, wherein the cam plate further comprises a slot wherein a protrusion of the lock lever is inserted and swings the lock lever around the axis of the hinge pin in connection with the rotation of the cam plate.

5. A method of distributing the load on a lock gear of a reclining device, comprising:
providing a pair of lock levers, one on each side of the lock gear, wherein when in operation a load appears on either side of an engaged lock gear, that load is distributed through a corresponding lock lever to a cam and again to the lock gear in a circular fashion.

6. The method of claim 5, wherein said lock levers are rotatable about a defined axis.

7. The method of claim 5, wherein a load appearing on the right side of a lock gear is distributed in a counter-clockwise fashion.

8. The method of claim 5, wherein a load appearing on the left side of a lock gear is distributed in a clockwise fashion.
